(19) United States
(12) Patent Application Publication
(10) Pub. No.: US 2008/0238614 A1
(43) Pub. Date: Oct. 2, 2008

(54) METHOD AND SYSTEM FOR SECURING AND RECOVERING A WIRELESS COMMUNICATION DEVICE

(75) Inventors: David J. Delia, Lagrangeville, NY (US); Wayne M. Delia, Poughkeepsie, NY (US)

Correspondence Address: Cantor Colburn LLP - IBM Endicott, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/693,813

(22) Filed: Mar. 30, 2007

(51) Int. Cl. G06F 7/00

(52) U.S. Cl. 340/5.85

(57) ABSTRACT

A method of securing a wireless device, includes: receiving, from a subscriber, a request to activate one or more security features and recovery functions of a missing wireless device; determining whether the wireless device is powered on; setting, in the event the wireless device is not powered on, a flag in an account of the subscriber to activate the requested functions upon determining the wireless device is powered on; activating, upon determining the wireless device is powered on, the requested functions by blowing at least one of a series of electrically programmable fuses included within the wireless device; and deactivating by blowing at least another of a series of electrically programmable fuses, in the event of receiving another request from the subscriber, the one or more security features and recovery functions, so as to reinstate a set of standard operating features of the wireless device.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates generally to wireless communication devices, and more particularly to a method, apparatus, and system for remotely configuring, activating, and deactivating a wireless communication device's security features for facilitating return of the device, as well as securing data stored within the device.

2. Description of the Related Art

The spread of wireless communication devices throughout societies around the world continues unabated. What started out as simple wireless phones in the 1970's have evolved into the sophisticated wireless information appliances that are now available today. Present day wireless information appliances include sophisticated cellular phones with data capabilities, Internet access, video and picture taking capabilities, advanced alphanumeric pagers, personal digital assistants (PDA), global positioning satellite (GPS) location devices, and portable computers. Even with the increased functionality of today's wireless devices, their size and ease of portability has continued to improve. Advancements in microprocessors, software, memory, power management/power cells, and display technology have allowed for smaller wireless devices.

The reduction of wireless device size has increased the chances for device loss or theft. The unauthorized use of a wireless device can lead to calls and services being charged to a user/owner account. More importantly, the party in possession of the device can access sensitive personal or business related data of the user/owner.

Solutions exist today that allow a user to secure their wireless device by permanently disabling data access within the device. However, this solution does not allow for reuse of the wireless device by the owner if the device is recovered. Therefore there is a need to remotely secure/disable a misplaced or stolen wireless device, while still allowing for restored functionality if the device is found by its owner, or the potential return of the wireless device by an honest individual.

### SUMMARY OF THE INVENTION

Embodiments of the present invention include a method and system for securing a wireless device wherein the method includes: receiving, from a subscriber, a request to activate one or more security features and recovery functions of a missing wireless device of the subscriber; determining whether the missing wireless device is powered on; setting, in the event the missing wireless device is not powered on, a flag in an account of the subscriber to activate the requested one or more security features and recovery functions upon determining the missing wireless device is powered on; activating, upon determining the missing wireless device is powered on, the requested one or more security features and recovery functions by blowing at least one of a series of electrically programmable fuses included within the wireless device; and deactivating, in the event of receiving another request from the subscriber, the one or more security features and recovery functions; wherein deactivating the one or more security features and recovery functions is facilitated by blowing at least another of a series of electrically programmable fuses included within the wireless device so as to reinstate a set of standard operating features of the wireless device.

A system for securing a wireless device, the system includes: subscriber wireless devices equipped with a series of electrically programmable fuses; a wireless provider network comprised of base stations and computer servers with storage capabilities; wherein the wireless provider network can remotely activate the wireless device's security and recovery features upon receiving, from a subscriber, a request to activate one or more security features and recovery functions of a missing wireless device of the subscriber, and deactivating, in the event of receiving another request from the subscriber, the one or more security features and recovery functions; wherein activating the wireless device's security and recovery features is facilitated by blowing at least one of the series of electrically programmable fuses included within the wireless device; wherein the blowing of at least one of the series of electrically programmable fuses results in a logic redirection from a set of standard device operating features to a restricted set of software functions intended to secure and potentially recover the lost wireless device; and wherein deactivating the wireless device's security and recovery features is facilitated by blowing at least another of a series of electrically programmable fuses to reinstate the wireless device's set of standard operating features.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, a solution is technically achieved for remotely configuring, activating, and deactivating a wireless communication device's security features for facilitating return of the device as well as securing data stored within the device.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a flow diagram illustrating a method for securing and setting parameters for recovery of a wireless device according to an embodiment of the invention.

FIG. 2 illustrates a system for implementing embodiments of the invention.

The detailed description explains the preferred embodiments of the invention, together with advantages and features, by way of example with reference to the drawings.

### DETAILED DESCRIPTION

Embodiments of the invention provide a means for remotely configuring, activating, and deactivating a wireless communication device's security features for facilitating return of the device as well as securing data stored within the device.

Embodiments of the invention use IBM's eFuse technology to provide remote field programmable low cost logic redirection from standard communication device operating features to a restricted set of software functions intended to secure and potentially recover a lost wireless communication or wireless computing device. The software configuration of a sequence of alternate, restricted functions is activated upon notifying a wireless communication service provider of a lost device. The restricted functions include display of a pre-specified text message, restriction of outgoing communication to a single destination, conversion of an alert to an audible ring tone, recording of the geographic location of the lost device by the service provider, securing access to data on the lost device, and encryption and upload of specified data files to a service provider. The use of firmware modification of a device's logic path via eFuse to lock out standard features, allows for re-activation of the devices full capabilities and access to stored user data if the missing device is located or returned.

An IBM eFuse is an electrically programmable, silicided polysilicon fuse that is embedded into a chip layer as an integrated portion of the chip manufacturing process. With the eFuse's microscopic size, hundreds of eFuses can be embedded into a very small portion of a chip, for use in programming/reprogramming chip circuit sections, thereby providing control over chip function and capability. The eFuse is the element that is “blown” by a sensing/control program, which causes an electro migration event within the eFuse. The blowing of an eFuse does not involve a physical rupture of the fuse element. The eFuse is blown with the application of a higher-than-nominal voltage in the logic circuit. eFuses provide several compelling advantages over laser fuses and/or conventional metallic fuses. The eFuse blow process does not risk damage to adjacent devices, since eFuses are blown by a logic process instead of a physical destruction of an element/filament. When a higher-than-nominal voltage is applied to a specific eFuse, electro migration of the silicide layer occurs, causing a substantial increase in resistance. This increase in resistance is sensed as a blown fuse in the eFuse sensing circuit.

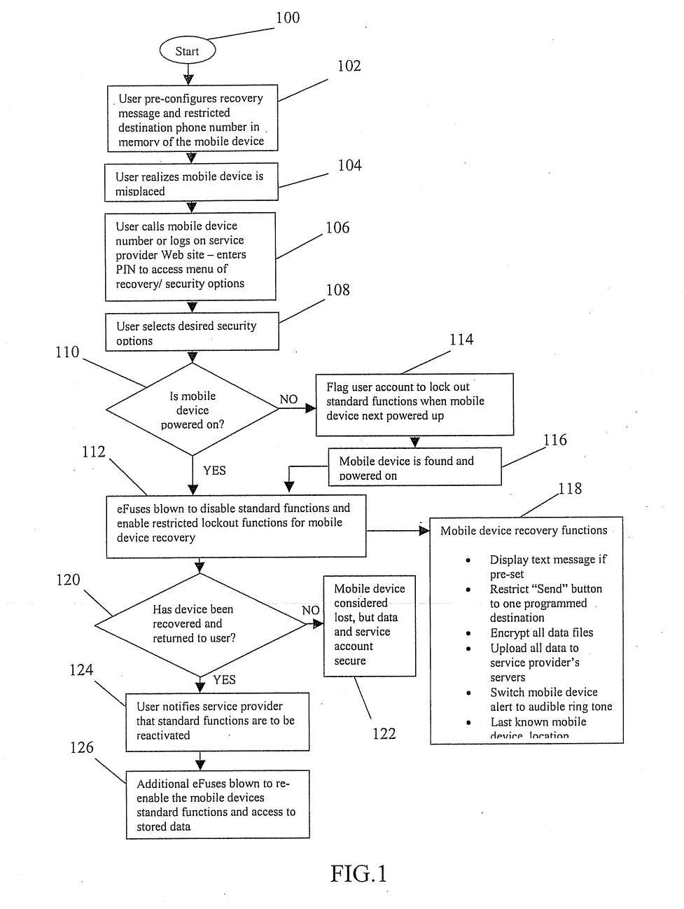

FIG. 1 is a flow diagram illustrating a method for securing and setting parameters for recovery of a wireless mobile device according to an embodiment of the invention. The method starts at block 100 with the user pre-configuring a recovery message to be displayed on a misplaced or stolen wireless device, and inputting a restricted recovery phone contact number into the device's memory (block 102). Restricting the phone contact number only allows the wireless device to reach the designated number, and the appropriate emergency number for the geographic location. When the user realizes that their wireless device is missing (block 104), they can either call the wireless device and enter a personal identification number (PIN), or log on to the website of the wireless service provider (with their PIN) to enter a menu (e.g., alphanumeric, voice, graphical user interface (GUI)) of recovery/security options (block 106). The user selects their desired security/recovery options with the menu (block 108), including the pre-configured contact number and recovery message as set in block 102, and features from among the wireless mobile devices security and recovery functions of block 118. If it is determined at decision block 110 that the wireless device is powered on, a series of eFuses are blown to disable the standard operating functions of the wireless device, and to enable restricted lockout functions for wireless device recovery (block 112). On the other hand, if it is determined at decision block 110 that the wireless device is in an off state at the time of loss, the user's account is flagged in the service provider's system (e.g., server or cellular base station network) to initiate the lockout of the standard functions of the wireless device upon power up of the subscriber's wireless device (block 114). If the wireless device is then found and powered on by a stranger (block 116), the service provider initiates the security/recovery options and the eFuses in the lost wireless device are blown to disable the standard features of the device (block 112).

As reflected in block 118, the wireless mobile devices security and recovery functions include one or more of the following features:
Displaying a pre-set text message on how to return the wireless device to the owner
Restricting the wireless device to a predefined contact number for the return of the device and emergency calls
Encrypting all files and data on the wireless device
Uploading the encrypted data from the wireless device to a storage area on the wireless providers network (in case wireless device is never recovered)
Recording locations of the wireless device based on transmissions received by wireless provider, and furnishing the location information to the owner/wireless subscriber on a mapped based graphical user interface (GUI) that is available on the wireless provider's Web site
Switching the wireless device to an audible tone alert from a quiet or vibrate mode, and sending out periodic beeps or chirps to attract attention to the lost device

Continuing with the flow diagram of FIG. 1, if the disabled wireless device is returned to the user/owner (as reflected in decision block 120), the user/owner notifies the service provider that they have possession of the device and request that standard functionality be restored to their wireless device (block 124). Following verification that the user/owner is indeed the individual initiating the service restoration request, the service provider blows additional eFuses to remotely re-enable the wireless device's standard functions and user access to personnel data stored on the device (block 126). In the worst case scenario if the wireless device is not returned, the device is considered lost, but data and the service account are secure (block 122). The owner/user can obtain a new device and download their previous data from the service provider that was uploaded from the lost device.

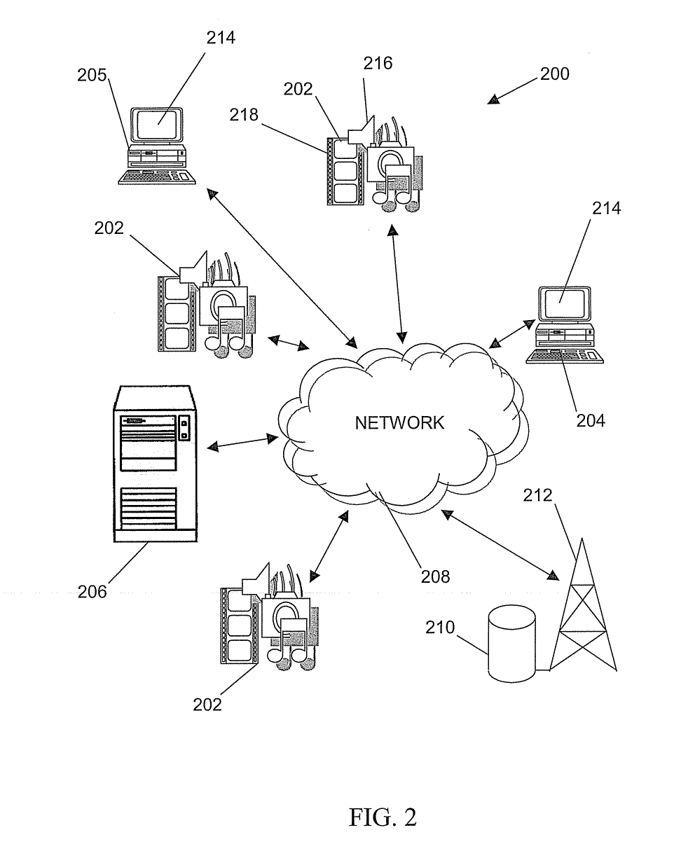

FIG. 2 is a block diagram of an exemplary system 200 for remotely configuring, activating, and deactivating a wireless communication device's security features for facilitating return of the device as well as securing data stored within the device. The system 200 includes remote devices including one or more multimedia/communication devices 202 equipped with speakers 216 for implementing audio, as well as display capabilities 218 for facilitating the graphical user interface (GUI) and Internet aspects of the present invention. In addition, mobile computing devices 204 and desktop computing devices 205 equipped with displays 214 for use with the GUI and Internet of the present invention are also illustrated. The remote devices 202 and 204 may be wirelessly connected to a network 208. The network 208 may be any type of known network including a local area network (LAN), wide area network (WAN), global network (e.g., Internet), intranet, etc. with data/Internet capabilities as represented by server 206. Communication aspects of the network are represented by cellular base station 210 and antenna 212. Each remote device 202 and 204 may be implemented using a general-purpose computer executing a computer program for carrying out embodiments of the wireless mobile device security described herein.

The computer program may be resident on a storage medium local to the remote devices 202 and 204, or maybe stored on the server system 206 or cellular base station 210. The server system 206 may belong to a public service. The remote devices 202 and 204, and desktop device 205 may be coupled to the server system 206 through multiple networks (e.g., intranet and Internet) so that not all remote devices 202, 204, and desktop device 205 are coupled to the server system 206 via the same network. The remote devices 202, 204, desktop device 205, and the server system 206 may be connected to the network 208 in a wireless fashion, and network 208 may be a wireless network. In an exemplary embodiment, the network 208 is a LAN and each remote device 202, 204 and desktop device 205 executes a user interface application (e.g., web browser) to contact the server system 206 through the network 208. Alternatively, the remote devices 202 and 204 may be implemented using a device programmed primarily for accessing network 208 such as a remote client.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method of securing a wireless device, the method comprising:
receiving, from a subscriber, a request to activate one or more security features and recovery functions of a missing wireless device of the subscriber;
determining whether the missing wireless device is powered on;
setting, in the event the missing wireless device is not powered on, a flag in an account of the subscriber to activate the requested one or more security features and recovery functions upon determining the missing wireless device is powered on;
activating, upon determining the missing wireless device is powered on, the requested one or more security features and recovery functions by blowing at least one of a series of electrically programmable fuses included within the wireless device; and
deactivating, in the event of receiving another request from the subscriber, the one or more security features and recovery functions;
wherein deactivating the one or more security features and recovery functions is facilitated by blowing at least another of a series of electrically programmable fuses included within the wireless device so as to reinstate a set of standard operating features of the wireless device.

2. The method of claim 1, wherein the request to activate one or more security features and recovery functions of a missing wireless device further comprises a call placed to the missing wireless device.

3. The method of claim 1, wherein the request to activate one or more security features and recovery functions of a missing wireless device is made by accessing a website of a service provider of the wireless device.

4. The method of claim 1, wherein in the security and recovery features of the wireless device comprise one or more of:
displaying a pre-set text message on how to return the wireless device to the subscriber;
restricting the wireless device to a predefined contact number for the return of the device and emergency calls;
encrypting all files and data on the wireless device;
uploading data from the wireless device to a storage area on a service provider's network;
recording locations of the wireless device based on transmissions received by the service provider, and furnishing the location information to the subscriber on a mapped based graphical user interface (GUI) that is available on a website of the service provider; and
switching the wireless device to an audible tone alert.

5. The method of claim 4, wherein the pre-set text message is configurable by the subscriber.

6. A system for securing a wireless device, the system comprising:
subscriber wireless devices equipped with a series of electrically programmable fuses;
a wireless provider network comprised of base stations and computer servers with storage capabilities;
wherein the wireless provider network can remotely activate the wireless device's security and recovery features upon receiving, from a subscriber, a request to activate one or more security features and recovery functions of a missing wireless device of the subscriber, and deactivating, in the event of receiving another request from the subscriber, the one or more security features and recovery functions;
wherein activating the wireless device's security and recovery features is facilitated by blowing at least one of the series of electrically programmable fuses included within the wireless device;
wherein the blowing of at least one of the series of electrically programmable fuses results in a logic redirection from a set of standard device operating features to a restricted set of software functions intended to secure and potentially recover the lost wireless device; and
wherein deactivating the wireless device's security and recovery features is facilitated by blowing at least another of a series of electrically programmable fuses to reinstate the wireless device's set of standard operating features.

7. The system of claim 6, wherein the request to activate one or more security features and recovery functions of a missing wireless device further comprises a call placed to the missing wireless device.

8. The system of claim 6, wherein the request to activate one or more security features and recovery functions of a missing wireless device is made by accessing a website of a service provider of the wireless device.

9. The system of claim 6, wherein in the security and recovery features of the wireless device comprise one or more of:
displaying a pre-set text message on how to return the wireless device to the subscriber;
restricting the wireless device to a predefined contact number for the return of the device and emergency calls;
encrypting all files and data on the wireless device;
uploading data from the wireless device to the storage area on the service provider's network;
recording locations of the subscriber wireless device based on transmissions received by the wireless provider network, and furnishing the location information to the subscriber on a mapped based graphical user interface (GUI) that is available on a service provider's Web site; and
switching the subscriber's wireless device to an audible tone alert.

10. The system of claim 9, wherein the pre-set text message is configurable by the subscriber.
